(19) United States
(12) Patent Application Publication
(10) Pub. No.: US 2016/0377062 A1
(43) Pub. Date: Dec. 29, 2016

(54) Power Turbine Incorporating Torque Accumulation and Energy Storage

(71) Applicant: Roberto Vallejo, Los Angeles, CA (US)

(72) Inventor: Roberto Vallejo, Los Angeles, CA (US)

(21) Appl. No.: 15/154,498

(22) Filed: May 13, 2016

Related U.S. Application Data
(60) Provisional application No. 62/133,441, filed on Mar. 15, 2015.

(51) Int. Cl. F03D 15/20; F03D 80/70; F03D 9/00; F03D 13/20; F03D 1/06; F03D 3/06

(52) U.S. Cl. CPC F03D 15/20; F03D 1/065; F03D 3/062; F03D 9/002; F03D 13/20; F03D 80/70; F05B 2260/402

(57) ABSTRACT

A power producing turbine comprising a flexible cable in a torque transmitting transmission, to accumulate force and to attenuate fluctuations in transmitted torque. The turbine includes a tower on which the turbine is mounted, and a generator receiving torque from the transmission. The flexible cable has a ratchet at each end to prevent unwinding. Thrust bearings maintain the flexible cable straight and unkinked. The generator may be located at ground level. The turbine may be a vertical or horizontal axis wind turbine. The flexible cable may comprise for example an assembly of flexible metallic strands.

### CROSS REFERENCE TO RELATED APPLICATION

This application claims the benefit of the filing date under 35 USC 119(e) of the filing date of U.S. Provisional Application Ser. No. 62/133,441 filed on Mar. 15, 2015, which was revived pursuant to 37 CFR 1.78b for the purpose of the present claim of priority, the contents of which are incorporated herein by reference.

### FIELD OF THE DISCLOSURE

The present disclosure relates to temporarily storing and transferring power in fluid turbines, such as wind and water turbines from a collector at the source of kinetic energy to an electricity producing generator at ground base level.

### BACKGROUND

Power developing turbines which exploit power of moving wind or water are subject to fluctuations in inputs and outputs. Notably, increasing or decreasing wind and water velocities can cause corresponding changes in velocities of torque transmitting components of the turbine. This type of disruption can be temporarily stored and increased at low to mid wind velocities and transferred to power producing components in a power developing turbine at mid to high wind velocities. Also, generator output can vary with rapidly changing wind or water current velocities. Generally, electrical supply systems operate best under constant conditions, so that such variation disrupts electrical system operations.

### SUMMARY

The disclosed concepts address the above stated situation by providing a power producing turbine having accommodation in its power transmission apparatus for the above noted variables. A flexible long cable in the power transmission path has potential to temporarily store fluctuations in power input from wind and water currents, and to increase stored torque when power from wind drops due to low wind velocity and to transmit torque to generator at mid to high wind velocities to generate electricity.

To these ends, a power producing turbine comprises a tower, a turbine rotatably coupled to the tower, a generator, and a transmission connected to the turbine and to the generator. The transmission comprises a rotatable torque transmission element further comprising a long flexible cable arranged to receive torque from the turbine and temporarily store fluctuations in torque at low to mid wind velocities and to transmit torque to the generator at mid to high wind velocities.

It is an object to provide improved elements and arrangements thereof by apparatus for the purposes described which is inexpensive, dependable, and fully effective in accomplishing its intended purposes.

These and other objects will become readily apparent upon further review of the following specification and drawings.

### BRIEF DESCRIPTION OF THE DRAWINGS

Various objects, features, and attendant advantages of the disclosed concepts will become more fully appreciated as the same becomes better understood when considered in conjunction with the accompanying drawings, in which like reference characters designate the same or similar parts throughout the several views, and wherein:

FIG. 1 is a side view of a vertical axis wind turbine, according to at least one aspect of the disclosure; and

FIG. 2 is a partial side view of the top of a horizontal axis wind turbine, according to at least one aspect of the disclosure.

### DETAILED DESCRIPTION

In the following description, numerous specific details are set forth in order to provide an understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

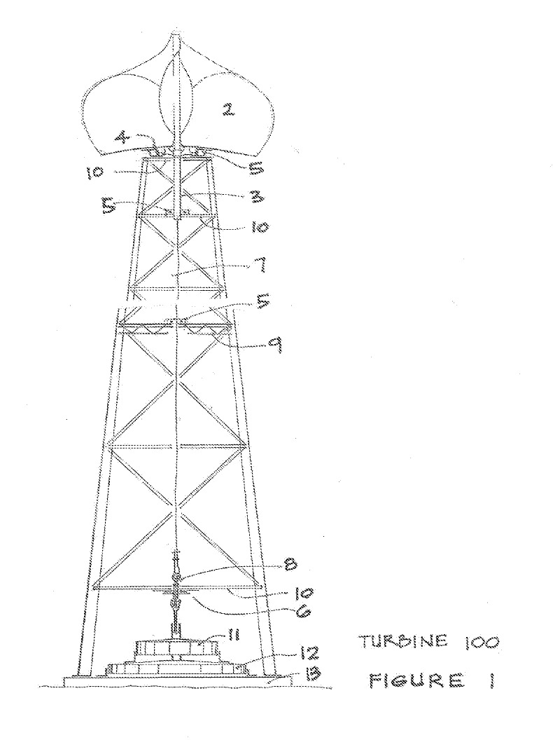

Referring first to FIG. 1, according to at least one aspect of the disclosure, there is shown a power producing turbine 100 comprising a tower 1, a turbine 2 rotatably coupled to tower 1, a generator 12, and a transmission connected to turbine 2 and to generator 12. The transmission comprises a rotatable torque transmission element further comprising a flexible cable 7 arranged to receive torque from turbine 2 and to temporarily store and increase power in fluctuations of torque at low to mid wind velocities and transmit torque to generator 12 at mid to high wind velocities. Power producing turbine 100 further comprises a first thrust bearing 5 (additional thrust bearings 5 are shown in FIG. 1 added for extra support of cable when long and heavy as needed) at an upper end of the flexible cable or top of the short rigid shaft and a second thrust bearing 6 at a lower end of the flexible cable 7. Top thrust bearing 5 and bottom thrust bearing 6 are positively anchored to tower 1 and oppose linear contraction of flexible cable 7 wherein the upper end of flexible cable 7 and the lower end of flexible cable 7 pull one another when cable 7 is tightly twisted under storage mode but positively anchored thrust bearings 5 and 6 hold in place storing energy temporarily.

Plates 10 and or trusses 9 provide support platforms for other components of power producing turbine 100 and 200, as will be described hereinafter. In the example of FIG. 1, turbine 2 may be a vertical axis wind turbine 100. Vertical axis wind turbines are able to exploit horizontal winds impinging on turbine 2 from any horizontal direction, and may be advantageous where wind directions change abruptly. Preferably, tower 1 is a tall tower (e.g., greater in height than nearby obstructions such as buildings, tress, terrain, hills etc.), such that turbine 2 will be located in winds of speeds greater than at the surface of the ground, and in winds experiencing minimal turbulence. Generator 12 and speed increaser 11 may be located on a structural base 13 to which tower 1 is anchored.

The transmission comprises a ratchet 4 at an upper end, wherein the ratchet 4 is configured to oppose unwinding of flexible cable 7 when torque is stored in the tensed twisted cable 7 that wants to reverse rotation and the ratchet 4 prevents the reverse rotation at top and the generator 12 speed increaser 11 friction prevents its rotation at base during low to mild wind velocities when cable 7 is under storage mode. The rotatable torque transmission element may comprise several components, some of which may be rigid, such as short rigid shaft 3, u-joint 8, others which rotate in place such as the ratchet 4 and thrust bearings 5 and 6, and others of which may be flexible such as long flexible cable 7. Rigid components such as short rigid shaft 3 enable robust anchorage of the rotatable turbine, and also enable maximizing the total length of the flexible cable 7 to maximize the temporary stored energy.

The ratchet 4 constrains the rotatable torque transmission element from reversing direction of rotation, as occur when winds die down. The ratchet may be combined with top thrust bearing 5, or alternatively, may be a ratchet action one-way hub 4 which engages flexible cable 7, and may be connected above or below to upper thrust bearing 5, and is anchored to tower 1. Regardless of whether the ratchet 4 is above or immediately below upper thrust bearing 5, it is located at the upper end of rotatable torque transmission element close to the kinetic energy collector 2.

When winds are below the minimum threshold to rotate the generator 12, but above the threshold to rotate the turbine 2, the flexible cable 7 will twist before rotating the generator 12 thereby storing some of the energy. This provides the turbine a “running start” that will allow the generator 12 to rotate at a wind speed below the minimum threshold wind speed to rotate the rotating generator 12. This will then lower the inertia forces required to rotate the generator as the wind speed increase to the minimum threshold to rotate the generator 12. Further, when wind speeds decrease and fall below a threshold for rotating the generator 12 to produce usable power, some power will be obtained from the twisted flexible cable 7, thereby allowing winds slightly less than the threshold speed to produce power by generator 12. The cable 7 may unwind only partially, so that winds of speeds lower than the threshold will initially accelerate turbine 2 prior to torque being transmitted to generator 12. It would be possible in some embodiments to release the ratchet to unwind flexible cable 7. Thus, on both sides of the spectrum—as wind speeds approach and fall below the minimum wind speed to rotate the generator 12, the current disclosed device will develop energy sooner and longer than would be the case in the absence of a flexible cable 7, for example if a solid rod was used.

The upper thrust bearing 5 is used with lower thrust bearing 6, and also limits tension imposed on turbine 2 and its shafting. Lower thrust bearing 6 prevents tension from the cable from being transferred to generator 12 and its gearing. Upper thrust bearing 5 is fixed to tower 1 by suitable plates 10, trusses 9, or the like. Lower thrust bearing 6 may be similarly fixed to tower 1. The rotatable torque transmission element may comprise a universal joint 8, to accommodate transient misalignments of rotatable torque transmission element components due to variations in wind speeds for example or transferring torque from one component to another in the transmission element.

Flexible cable 7 is preferably made of steel and may comprise an assembly of twisted steel strands, for example, or even a torsion spring or a combination thereof. The flexible cable 7 is flexible in a direction such that an initial input from the turbine tightens and winds up the flexible cable. Of course, other materials having suitable characteristics may be used, such as copper and its alloys, plastics, carbon, vegetable, or synthetic fibers, grapheme, and others, and combinations of these.

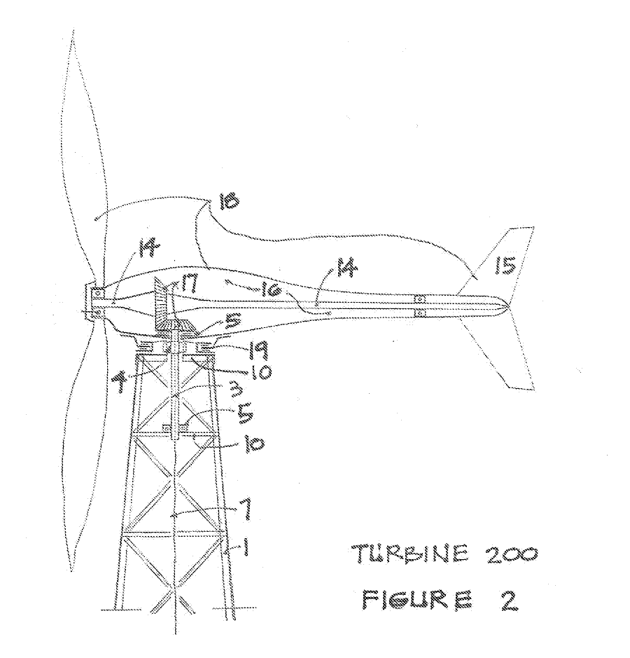

Turning now to FIG. 2, in a power producing turbine 200, turbine 18 is a horizontal axis wind turbine comprising a horizontal power shaft 14. Power producing turbine 200 may further comprise an angled gearset 17 converting a horizontal axis of rotation of turbine 18 to a short vertical axis of rotation 3 of the rotatable torque transmission element comprising a strong short rigid shaft 3 and long flexible cable 7. Power producing turbine 200 may further comprise a nacelle 16 enclosing horizontal power shaft 14 and angled gearset 17. Power producing turbine 200 may further comprise at least one stabilizing fin 15 oriented to align horizontal power shaft 14 longitudinally with oncoming wind; or a yaw mechanism as in large scale wind turbines. Alternatively stated, horizontal power shaft 14 is parallel to oncoming wind because of stabilizing fins 15 or yaw mechanisms depending on scale of turbine, thereby stabilizing nacelle 16 and its contents to face the wind. Bearing 19 accommodates rotation of nacelle 16 as the latter adjusts position to face into oncoming wind and is anchored to tower top, concentric with vertical element of gearset 17, and vertical short rigid strong shaft 3 and cable 7. Power producing turbine 200 may share a number of components in common with power producing turbine 100, such as tower 1, short strong rigid shaft 3, flexible cable 7, generator 12, structural base 13, as well as unidirectional controller ratchet 4, thrust bearings 5 and 6, and universal joint 8 described hereinbefore.

Power producing turbine 200 comprises tower 1 extending vertically from a ground surface and comprising an upper end and a ground end. Turbine 18 is rotatably coupled to tower 1 proximate the upper end. Generator 12 is proximate the ground end. Transmission is connected to turbine 2 and to generator 12. Transmission comprises a rotatable torque transmission element further comprising a flexible cable 7 arranged to receive torque from turbine 2 and to store fluctuations in torque at low to mid wind velocities and to transmit torque to generator 12 at mid to high wind velocities. The flexible cable 7 enables temporary storage of energy torque for power producing turbine 200, as occurs with power producing turbine 100.

Because generator 12 and speed increaser 11 are located proximate the ground end of tower 1, the generator 12 and speed increaser 11 will be easier to service, build, maintain, and will not have to be engineered to the same exacting level as a generator 12 speed increaser 11 housed in the upper end of the tower, thereby reducing production, construction and maintenance costs.

Generator 12 is arranged to have a vertical axis of rotation aligned with the rotatable torque transmission element that includes the short rigid shaft 3, the long steel cable 7, and the u-joint 8.

In an embodiment of a turbine generally similar to turbines 100 and 200 but not shown, the turbine may be a water turbine. In this embodiment, a power producing turbine using a water turbine may share components in common with wind turbines 100 and 200 where feasible, such as tower 1, short rigid shaft 3, flexible cable 7, generator 12, speed increaser 11, and structural base 13, as well as unidirectional controller ratchet 4, thrust bearings 5 and 6, and universal joint 8 described hereinbefore.

Flexible cable 7 may be replaced by another type of torsion spring (not shown).

In another embodiment the turbines can be anchored off shore.

While the disclosed concepts have been described in connection with what is considered the most practical and preferred implementation, it is to be understood that the disclosed concepts are not to be limited to the disclosed arrangements, but are intended to cover various arrangements which are included within the spirit and scope of the broadest possible interpretation of the appended claims so as to encompass all modifications and equivalent arrangements which are possible.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications in size or scale and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A power producing turbine, comprising:
a tower;
a turbine rotatably coupled to the tower;
a generator; and
a transmission connected to the turbine and to the generator, wherein the transmission comprises a rotatable torque transmission element further comprising a long flexible cable arranged to receive torque from the turbine and to store fluctuations in torque and transfer torque to the generator.

2. The power producing turbine of claim 1, further comprising a first thrust bearing at an upper end of the flexible cable and a second thrust bearing at a lower end of the flexible cable, wherein the first thrust bearing and the second thrust bearing are anchored to the tower and oppose linear contraction of the flexible cable wherein the upper end of the flexible cable and the lower end of the flexible cable approach one another.

3. The power producing turbine of claim 1, wherein the turbine is a vertical axis wind turbine.

4. The power producing turbine of claim 1, wherein the turbine is a horizontal axis wind turbine comprising a horizontal power shaft.

5. The power producing turbine of claim 4, further comprising an angled gearset converting a horizontal axis of rotation of the turbine to a vertical axis of rotation of the rotatable torque transmission element.

6. The power producing turbine of claim 5, further comprising a nacelle enclosing the horizontal power shaft and the angled gearset.

7. The power producing turbine of claim 6 wherein the nacelle rotates to face the wind anchored to a bearing, that is anchored to the tower top and is concentric with the angled gearset short rigid vertical shaft, and the flexible cable vertical axis.

8. The power producing turbine of claim 4, further comprising at least one stabilizing fin or a yaw mechanism to align the horizontal power shaft longitudinally with oncoming wind.

9. The power producing turbine of claim 1, wherein the transmission comprises a ratchet at an upper end of the transmission, wherein the ratchet is configured to oppose untwisting of the flexible cable when torque from the turbine is not being imposed on the generator.

10. The power producing turbine of claim 1, wherein the rotatable torque transmission element comprises universal joints.

11. The power producing turbine of claim 1, wherein the flexible cable is twisted in the same direction as the rotation.

12. The power producing turbine of claim 1, wherein the flexible cable comprises an assembly of flexible strands.

13. The power producing turbine of claim 1, wherein the generator is arranged to have a vertical axis of rotation aligned with the rotatable torque transmission element.
